(19) United States
(12) Patent Application Publication
(10) Pub. No.: US 2007/0028175 A1
(43) Pub. Date: Feb. 1, 2007

(54) Grid processing user tools

(76) Inventors: Dennis B. Moore, Hillsborough, CA (US); Igor Tsyganskiy, Los Gatos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/264,414

(22) Filed: Oct. 31, 2005

Related U.S. Application Data
(60) Provisional application No. 60/703,536, filed on Jul. 29, 2005.
(60) Provisional application No. 60/707,765, filed on Aug. 11, 2005.

(51) Int. Cl. G06F 9/00

(52) U.S. Cl. 715/733; 715/736; 715/734; 715/735

(57) ABSTRACT

Grid user tools enable access to information related to a grid network by a user. The grid user tools may provide interactive access to data objects, to allow the user to access additional information, and/or process/operations related to the data objects. The grid user tools can provide dynamic information displays, and provide up-to-date statistics related to the grid network.

### RELATED APPLICATION

This application claims the benefit of priority to U.S. Provisional Application No. 60/703,536 [Attorney Docket 6631.P050Z], filed Jul. 29, 2005, and to U.S. Provisional Application No. 60/707,765 [Attorney Docket 6631.P050Z2], filed Aug. 11, 2005.

This application is related to U.S. patent application Ser. No. 11/181,644 [Attorney Docket 6631.P038], entitled “Methods for Enterprise-Level Data and Process Access and Presentation,” and filed Jul. 13, 2005, and to U.S. patent application Ser. No. (TBD) [Attorney Docket 6631.P050], entitled “Grid Processing Dynamic Screensaver,” and U.S. patent application Ser. No. (TBD) [Attorney Docket 6631.P040], entitled “Grid Processing in a Trading Network,” both filed concurrently herewith.

### FIELD

Embodiments of the invention relate to grid processing, and more particularly to user tools for data access in an enterprise grid processing network.

### BACKGROUND

Grid processing systems traditionally fail to provide adequate mechanisms for interfacing data or information related to a grid. Many potential grid participants are uninformed about grids, which may prevent support and participation in a grid network. The lack of interface mechanisms to grids may prevent the time and money savings available to a company if a grid were utilized. Because grids are not easy to interface, the potential benefit to a user in work efficiency is typically unavailable to potential grid users.

### SUMMARY

One or more grid user tools can provide dynamic and/or interactive access to information related to a grid network. The grid user tools may include one or more network access portals to access the information related to the grid network. The grid user tools can be provided to a user on a display of a user interface.

### BRIEF DESCRIPTION OF THE DRAWINGS

The following description includes discussion of various figures having illustrations given by way of example of implementations of embodiments of the invention. The drawings should be understood by way of example, and not by way of limitation.

FIG. 1 is a block diagram of an embodiment of a composite application framework with a visualization agent.

FIG. 2 is a block diagram of an embodiment of design-time components of a composite application framework.

FIG. 3 is a block diagram of an embodiment of guided components for a composite application framework.

FIG. 4 is a block diagram of an embodiment of a user device with grid tools and a portal interfaced with enterprise and grid processing network data.

FIG. 5 is a block diagram of an embodiment of a user device with grid tools having access to grid data.

FIG. 6 is a block diagram of an embodiment of a user device with grid tools and a portal interfaced with a grid trading network.

FIG. 7 is a block diagram of an embodiment of a client device with a grid interface module.

FIG. 8 is a block diagram of an embodiment of a user display with grid data.

FIG. 9 is a block diagram of an embodiment of a user display showing grid data in response to activating an icon.

FIG. 10 is a block diagram of an embodiment of a user device having grid tools including a screensaver engine.

FIG. 11 is a block diagram of an embodiment of a user device with a display portal and an enterprise server having grid tools.

FIG. 12 is a block diagram of an embodiment of layers of an enterprise system to provide grid data to a user display.

### DETAILED DESCRIPTION

As used herein, references to one or more “embodiments” are understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Various discussions below refer to enterprise-level data. Enterprise-level data may include enterprise information and/or processes, and/or other enterprise objects/processes associated with information or processes. Enterprise information and/or processes are to be understood to include any data, process, and/or event that may be available within an enterprise system. In one embodiment the system takes into account permissions associated with a user to determine data to which a user should have access, and/or an amount of data available to an accessing user. The enterprise information or processes may include master data or business objects, which refer generally to management information, project or process coordination data, etc. Process metadata may refer to related or incidental that may not be strictly considered part of a process, but provides information or insight into a process, a direction or end result of the process, etc. Smart forms may refer to documents or programs that allow the incorporation of external material. The external material may be from other documents, or be provided interactively with a user. Smart forms can be used to avoid duplication of information already available elsewhere in the enterprise system. Exceptions/alerts may refer to warnings or errors resulting from a process or an action that produce an unexpected or unwanted condition/action. The exception can be generally triggered, for example, by an unrecognized condition, or triggered by a specific condition for which the system watches. Project events may refer to access of a project, which may be a series or group of related or dependent processes, steps, and/or actions, or may refer to something spawned by a process, step, or action of a project. A user may instigate access to the project, or a project action may prompt a user to provide input. A project event may refer to initiating a project step, or providing input or reviewing a step in the project. Collaboration data may refer to information that provides for the comparison and/or synchronization of effort, or the coordination of a process. Help/tips/support information may refer generally to “suggestions,” which may be offered as help data, as well as prompts to a user. In the context of the system described herein, the suggestion may be general (e.g., spelling changes), as well as specific to a project on which a user is working (e.g., providing possibilities of specific information pulled from the enterprise that could complete a particular form the user is filling out).

Visualizations may include links to and/or abstractions of enterprise data, including business objects. As used herein, the term “business objects” should be understood to refer to traditional objects, or modeled data objects, information objects, as well as service objects or services in a service-oriented, or service-driven environment. Thus, just as business objects may be mentioned with respect to being associated with data and/or links, in a service-driven system data and/or links may be associated with a service. Thus, any mention of business objects should be understood as including reference to enterprise services. As used herein, business processes, or simply processes, may refer to the service objects and/or services of a service-oriented or service-driven environment.

In accessing and presenting enterprise information/processes, a system may take into account personal preferences, work context, and working mode. The personal preferences can allow a user to select from among various different working modes or work contexts in which to have information presented. The working mode can be one of many different possible modes, for example, exploration operation mode, search operation mode, detailed work and decision making operation mode, process analysis operation mode, and reporting mode. The enterprise information or processes accessed and presented can be any of a number of different data and/or events, for example, master data or business objects, process metadata, smart forms, exceptions/alerts, project events, collaboration data, and/or help/tips/support information. The accessing or navigating to information or processes may be implemented with different linking or navigation mechanisms/methods, for example, an action panel, a smart tag, an object link, a menu item, a right-button mouse click, and/or a push event. The presenting of the information may be implemented with different visualizations, for example, fish eye view, tabular view, chart form, relationship diagram, semantic network, project cockpit view, and/or with presenting relevant information via an automated voice method. The different implementations, visualizations, modes, and events/data can be combined in any combination to render a many permutations.

Enterprise data may be accessed via one or more navigation methods, which can include many different mechanisms for accessing or affecting data. In one embodiment the navigation methods can be considered to be activated or triggered. Activation or triggering of a navigation method may occur by a user selecting the particular mechanism (e.g., performing a mouse-over, clicking on a menu item, etc.). The activation or triggering prompts the system to enable the action associated with the navigation mechanism or method. As to some specific types of navigation, an action panel may refer to a list of action options displayed within a tab or a screen. The action panel may refer to options available to the user for performing specific functions or engaging in specific processes or providing specific information. A smart tag may refer to an XML (extensible markup language) embedded “tag” within a document. The smart tag may recognize words, sets of words, application programs, databases, etc., and provide a service or function when a recognized combination is found. For example, the smart tag may bring up a series of documents, begin an application, link to a database, launch a website, charge a purchase to an account or credit card number, append version related information to an edited document, etc. A smart tag can link together back end systems to enable a user to work, in one application, with live data from various sources, as provided herein. An object link may refer to an embedded trigger within a document or a program to provide a link to another item (e.g., a process, a data element), which may have particular characteristics that are related or similar. A menu item may refer to an item in a program, for example, a drop-down menu. A menu item may be considered to be similar to an action panel, and an object link may be considered to be similar to a smart tag. A right-button mouse click may refer to a resulting menu or selection from activating a secondary, utility button on a mouse. Note that most mice that include two or more buttons default to having the left button provide selection, and the right button to provide alternative functions or utilities (e.g., bringing up a menu). Many mice allow for the right and left button functionality to be swapped. Many mice also include a third, generally, middle button, which may provide additional features to a user. The expression “right-button mouse click” will be used generically herein to refer to the triggering of a utility button, and is not to be viewed as limiting. A push event may refer to a prompt or an action brought up for a user that may not be directly instigated by the user. As one example, an entity or process outside the context of the program in which the user is working may cause a prompt to be presented to the user.

The data may be presented in many different forms, which may or may not be native to the program in which the user is operating. For example, a program may present information in a particular form, and the same form of presentation or another may be provided in which to present data to the user. A fish eye view may refer to a presentation of information where details of data or processes are shown for elements close in layout or close in relatedness to information being browsed or worked on by a user. For example, in an EXCEL spreadsheet, when a user is viewing a particular cell, cells within close proximity, or cells with related data may be highlighted or show specific details, while other cells may not. In another example, a software program or working environment may have multiple panels or panes of information, and when a user is working within a particular panel, close panels may display detailed information, which more distant panels may simply show a title or subject heading. A tabular view may refer to the display of information in tables, or lists of data. A chart form may refer to various types of information display, for example, a pie chart, a bar graph, a graphical representation, or other form of chart. A chart is well suited for showing how data compares to other data. A relationship diagram may refer to a diagram or visual representation that shows relatedness and/or interaction between processes or data. The visual representation may include block or flow diagrams, and may show directly how elements are related. A semantic network may refer to a graphic representation of knowledge in patterns of interconnected nodes and arcs. A semantic network may show clusters of information and may provide information as to how a node is related to another node. A project cockpit view may refer to a project-driven display having the main tasks, processes, steps, aspects, of a project in a single view. Details may be available upon drilling down into a particular section of the “big-picture” display. Automated voice may provide a method of providing information through the playing of recordings, or through the software “reading aloud” information by generating an audible presentation of the data.

Tools related to the functioning of a grid trading network are provided, which can facilitate the work of grid users and encourage users to utilize the grid trading network. The tools can enable a grid computer user to interact with, and receive data and metrics from, a shared grid trading network. The grid tools add accessibility and interactive views of dynamic grid data, enabling a user to obtain information regarding what is taking place on the grid trading newtork in general, and specific information regarding the user's participation in the grid trading network. The user can interact with the grid trading network and have a systematic mechanism to access data from the grid trading network.

Various computing devices can be networked, or interconnected via a common medium and supporting access interface mechanisms. A network can also be utilized as a cooperative processing entity, where multiple networked machines or computing devices operate in conjunction, especially in parallel, on a problem. The cooperative processing entity or the network structure to enable the cooperative processing is referred to herein as a “grid.” Processing performed on or by a grid is referred to herein as grid processing. Thus, grid computing or grid processing is conducted with a grid or network of computing devices capable of processing commands in parallel, breaking up processing of operations into commands or operations that can be performed in parallel. Parallel operation or execution is in contrast to serial execution, in which a single computing device or “node” executes all operations of a series of operations. The parallel commands can be dispatched for processing to the appropriate execution nodes, and managed across the nodes of the grid. At the completion of execution, results can be collected and aggregated, and potentially further processed. Grid processing is otherwise known as distributed processing and as distributed dispatching. Some network implementations involve the interconnection of separate enterprises through a trading grid, where the trading partners can dispatch and install new trading capabilities between the trading partners over the grid.

For example, a heterogeneous implementation some enterprise software systems (client/server architecture) creates a complex distributed environment involving a repository and one or more application servers and one or more presentation servers. One specific example of such an enterprise software system is the SAP R/3 system available from SAP AG of Walldorf, Germany. The SAP system is specifically a system with an architecture that allows more servers to be added as needed. The servers can be coordinated in many ways, and which could provide a system that delivers and enables rapid and diffuse distributed processing. Again, as a specific example, the SAP R/3 system allows for any participant to become the hub, or the node, at a given time, and allows the node currently acting as the hub to send actual new computing functionality (e.g., programs, functions) to participant nodes across the grid. Sharing computing functionality rather than just sharing computer cycles enables much greater grid functionality.

In addition to having a grid network including enterprises with the same or similar technological infrastructure (e.g., two enterprises running the SAP R/3 system), the participants in the grid network need not have the same systems. For example, a grid network as described herein would apply equally well to two enterprises both running systems from SAP, as to one enterprise running a system from SAP and one enterprise running another system, and potentially to two enterprises both running non-SAP systems.

Grid user tools may include one or more of the following tools: a grid status indicator, a grid screensaver, grid use parameter settings, grid client security settings, and/or a grid newsletter. The grid user tools can present data related to the grid to a user and provide one or more mechanisms for accessing the data and interacting with the grid trading network. Presentation and interactivity can be provided through graphical representations, links, and data objects, each of which can present and provide access to data. The data may refer to statistics and/or summaries about the grid and/or its activity, and/or comparisons of grid data.

Data objects enable the grid user tools including the screensaver. As mentioned above, data objects refer to information objects or simply “objects,” which relate to enterprise data and/or grid data. A portal is created for or from/on the computing device of interest to connect, create, or otherwise use any object or objects. A portal as used herein refers to a single, controllable point of access. The portal refers to an interface from the computing device to the grid and/or the enterprise network. The controllable nature of the access refers to the ability to set parameters or limits on the scope of functionality of the portal. A portal may reference a single data object to allow access and/or visual representation of the object on the computing device. The portal can be created from the SAP ENTERPRISE PORTAL 6.0 (SAP EP). A portal is particularly useful for a heterogeneous enterprise software implementation which also involves a grid.

A portal may include one or more WebDynpro Views or iViews or type-able fields, or WebDynpro pages containing several iViews, each of which represents an interface mechanism to enable the portal to access the network. Either WebDynpro Views and/or iViews may be used, or some comparable technology. For ease of description, and not by way of limitation, the description herein will generally refer to WebDynpro Views. In one embodiment a WebDynpro page having multiple iViews can be used. Thus, the technologies are also not necessarily mutually exclusive. iViews and/or WebDynpro Views access and display data from across the grid trading network. WebDynpro Views also display data about the individual computing device as a member of the grid. WebDynpro Views allow settings to be made by the user. A WebDynpro View can enable a “type-able field” to allow input from a user. The WebDynpro View may include one or more function calls, routines, or sequences of instructions to cause certain operations in the computing device. In one embodiment the portals or WebDynpro Views may enable a port or channel connection to the network, for example, through access to enterprise business logic.

For presentation tools (e.g., grid status indicator, screensaver, newsletter), a portal may be populated with one or more “WebDynpro Views,” to enable access to data to present on the computing device. A display box or WebDynpro page or WebDynpro screen is created and WebDynpro Views can be created upon the display. For ease of description, and not by way of limitation, the term “WebDynpro page” may be used herein to represent a display box or page with WebDynpro Views or other comparable technology. In one specific implementation, SAP NETWEAVER VISUAL COMPOSER is used to create the WebDynpro page. SAP NETWEAVER VISUAL COMPOSER can also be used to access and display data objects from a backend SAP ENTERPRISE system and an SAP MYSAP BUSINESS SUITE, which can enable the shared grid. Once the WebDynpro Views are on the WebDynpro page, they can communicate with each other, as well as with the backend application, or the website whose data they display. The communication of a WebDynpro View with another WebDynpro View or other entity can be referred to as “eventing.” Any “event” in one WebDynpro View, such as a mouse click or other selection mechanism, can cause one or more other WebDynpro Views to display corresponding material. Thus, if multiple WebDynpro Views include related information among their data, their displays can be coordinated. For example, a WebDynpro View displaying Outside Grid Members can be displayed on a computing system. If a user selects a Growth Company's computer in the list of grid computers currently active in the grid, the other WebDynpro Views on a common portal display may immediately display any other information they have regarding the Growth Company's computer. The WebDynpro page can be customized to the individual preferences of any user, for example, regarding the overall layout. The layout customization is implemented by any user, simply by moving the WebDynpro Views around the screen, or adding or deleting a WebDynpro View. A user can also configure any WebDynpro View content.

The WebDynpro Views may also use monitoring to adjust to dynamic information on the grid. Each WebDynpro View can be configured for periodic polling for information and/or for external change-triggered eventing. In one specific implementation, monitoring can be performed with SYTEM LANDSCAPE MONITORING with the SAP ENTERPRISE PORTAL and the ENTERPRISE PORTAL SOLUTION LANDSCAPE, which employs the SAP CCMSR (Computing Center Management System Report) agent, which in turn receives monitoring from JMON (J2EE (JAVA 2 Enterprise Edition of SUN MICROSYSTEMS of Santa Clara, Calif.) Monitoring). One source of these monitoring tools is the SAP COMPUTING CENTER MANAGEMENT SYSTEM (CCMS), an application that contains an integrated suite of tools for monitoring and managing R/3 and independent SAP components.

A general description of each of the tools follows.

Grid Status Indicator

One embodiment of a presentation tool is a grid status indicator and grid data display. As mentioned above, a display can be generated and populated with WebDynpro Views. Each WebDynpro View can present one of the various types of above-mentioned data. In one embodiment one or two WebDynpro Views are used to display the pertinent data for activity in the grid. Another WebDynpro View can display the data for a particular computer's participation in the grid (i.e., the host computing device or the computing device on which the display is rendered, or another computing device). Another WebDynpro View can show comparative data, for example, how the participation of the host computing device compares against another computing device, how the participation of one department compares to another, how the work is coming with one problem as compared to another problem, etc. Another WebDynpro View could use data to enable a graphical indicator to display overall status information of the grid (e.g., topology, work being done, problems being solved, cycles being performed, etc.). Other WebDynpro Views could be used for other information.

The display can provide a mechanism for a user to interact with a grid trading network, and a systematic way to access data from the grid trading network. The data displayed may be interactive, allowing drilling down by the user to obtain additional information related to something being displayed on the status indicator, for example. The data displayed could allow access to an enterprise object related to a WebDynpro View to allow modificaiton of data or a process through the object.

As mentioned above, the overall layout of any installed display can be adapted to the preferences of the individual user. A user can customize a display by adding, deleting, or moving WebDynpro Views, or configuring any WebDynpro View content.

In one embodiment a display is configured to open as a program from clicking on or otherwise activating an icon on a desktop or workspace. In another embodiment the display is configured to open automatically on startup/boot-up or initialization. In implementations where the computing device includes a system tray or task bar, a grid icon may be placed in the system tray, or task bar, for example near a clock and date display. The grid icon could be treated as other icons present for systems and services that are running. Mousing-over or otherwise triggering the icon (e.g., double-clicking) could activate the display, or bring up a temporary display window (e.g., a pop-up window) that will disappear when the mouse-over period is over, or when the user switches to a different context (e.g., switches to an application). The display can be some or all of the information that might be present on an open display application, including one or more of what work the computing device has been performing, how much time the computing device has been participating in a work session, how much work the computing device has performed in terms of CPU (central processing unit) cycles, instructions, dollars, etc., or other information.

Visual indicators or displays that might be shown by the grid status indicator may include, but are not limited to any of the following. The display may include a number of computing devices that are currently operating in this grid. The display could indicate what percentage of grid work is being contributed by this computing device. For example, a display may indicate 41% of the processing time by this computing device is being used by the grid. The display of percentage of may indicate a percentile of contribution, for example, what is the relative contribution by this computing device in relation to the total number of participants. The display may indicate a number of items of interest this computing device has found, or a number of problem solving steps completed, etc. Contribution may also be measured by a benchmark, for example, number of cycles contributed, etc., or some unit of work.

Visual indicators or displays might indicate a geographical distribution (e.g., graphically) of participation. A participation distribution graph can be a map that shows where the grid is, with different colors/icons to show how much contribution from each location and/or participant, and/or other participation statistics. For example, a graphical representation of the grid may indicate a computing device that has provided the top level of participation on the grid for a current time period (e.g., day, month).

Visual indicators may indicate a grid uptime, referring to how long a grid has been active, a period of time it has been down, etc. The visual indicators may also indicate a number of current problems being worked, a number of problems solved, etc. Number of problems solved may be indicated by percentage of a total number of problems for a time period, e.g., 22% of, expected work for a given month. The visual indicators may indicate comparisons of grid participation statistics. For example, a comparison may be a percentile of grid contribution for this computing device versus another computing device, or versus other computing devices within the enterprise or department. In other words, how much time comparatively speaking is this computing device being used by the grid.

A display may indicate statistics to a particular computing device, for example, what the computing device is currently doing, a history of what this computing device has done, how long the computing device has been working in this session, how much contribution was made by this computing device today, and this week, this month, etc., to date. The particular computing device statistics can include a percentage of work done on this computing device by the grid versus work done by the computing device's normal user.

In one embodiment incentives are provided for grid participation, and steps toward the goal of reward may be displayed. The progress toward a landmark or a goal can be dynamically determined on the grid by the mechanisms discussed above, and shown for individual computing devices. Examples of progress may include an indication of an amount of participation by this department or location, a number of prizes won (e.g., t-shirts, free downloads, etc.) The progress may be similar to a “frequent flyer miles” awards program, where participation is accumulated in the form of points that can be converted to merchandise, services, etc.

Grid Screensaver

A grid screensaver could be generated to display any or all of the information described above with respect to the status indicator(s), and may include additional or different information. In one embodiment a pop-up or other WebDynpro page are available as a status indicator application, which may default for display as a “screensaver.” As used herein, screensaver refers to a program or process or application that is executed upon the triggering of an inactivity event. For example, many computing devices have a screensaver feature that enables the execution of some on-screen display if there has been no keyboard and cursor control activity for a configurable amount of time. The screensaver could thus be an extension of the visual display as applied to a screensaver.

Rather than being a traditional screensaver, however, the grid screensaver could appear as a conventional single-screen screensaver, but including one or more portals with an array of “WebDynpro Views” that access and display grid or other enterprise data. To generate the screensaver, in one embodiment a screensaver application with the portal coding can be created and stored on a machine. In another embodiment, the enterprise system can access a basic screensaver object already in existence, and then customize the screensaver object as a portal screensaver by generating WebDynpro Views on top of the screensaver. Implementations of the screensaver could be made to enable the screensaver with one or more user tools on it to provide a framework for user interaction with the grid.

Accessing the screensaver may include accessing a display engine of the screensaver application or object, and/or other functions of the screensaver to be used with the provided grid information to be displayed.

Grid Use Parameters

The grid user tools may include one or more tools related to configuring grid use parameters. The parameters can provide for different use scenarios based on conditions such as whether the computing device is on battery or plugged in, whether connecting through a wired or wireless local area network (LAN) connection or whether over dial-up. Monitoring and managing the grid and the interface of a computing device with the grid, and setting grid use parameters can be accomplished through systems available for administering any SAP systems. Also, monitoring, managing, and alert systems are included with all SAP Servers.

Among possible use parameters, some example include whether the computing device is on battery, or plugged in, indicating how much CPU to use when idle, how much CPU to use when not idle, how much idle time should occur before activating grid activity on the computing device, indicating permissible network connections (e.g., not when on VPN (virtual private network) or dial-up), etc. Grid use parameters may allow for certain amounts of grid activity on the computing device when on dial-up, which may be less than what is permitted on a wired LAN connection. Use parameters may also include how much disk space is made available for use by the grid, and perhaps more specifically, how much disk the grid can use for sending new functionality to this computing device, how much to use when caching data, etc.

Grid Client Security Settings

The grid user tools can provide grid security settings to provide limitations on use of or access to a computing device by a grid, for example, instructions on handling a situation where the grid wants to install new software on the computing device, whether the grid is allowed to use the disk on the computing device, whether the grid must authenticate (e.g., through a certificate), etc. In one embodiment an Internal Control System (ICS) is instituted to provide security and security controls settings, including the frequency of grid authentication. An ICS can be implemented, for example, with SAP EP. An ICS can be implemented on the computing device with enterprise software that includes access control, which may require identifying a user, authenticating the user, and/or system verification. In one specific implementation, enterprise software can provide an approved, new grid client with an SAP PASSPORT certificate for authentication, which provides more secure authentication than a user name and password. The security settings and authentication can be audited and monitored on a regular basis. The security monitoring and auditing may be handled in conjunction with SAP LANDSCAPE MONITORING.

Possible security settings may include one or more of the following. The computing device may include security settings for handling the installation of new grid clients or other grid-initiated software. The computing device may be set to prompt, deny, or permit, or some combination depending on the type of software and/or the purpose of the software. The computing device may include a setting related to whether or not the grid can use its disk, whether the disk access is through direct push, through an agent, or through other software on the computing device. The computing device may require a certificate to use for authentication. The certificate could be changed periodically to reduce the capacity for malware infestation. The periodicity or event-trigger for changing the certificate can be set by the user. A grid client may have a built-in rotating security mechanism that first asks how to authenticate (e.g., the method for authentication, the algorithm for authentication), to allow the grid client to respond to settings established by the user.

In one embodiment the enterprise includes an IT (information technology) policy for the maximum access allowable for the grid to the computing device, a maximum CPU percentage to use, a policy to reduce the CPU usage time by the grid, etc. The IT policy may be a default that is modifiable by settings at the computing device, or it may indicate maximums for the computing device. In another embodiment an enterprise IT policy could disallow particular computing devices from being grid participants because of the nature of a particular project being worked on by the user (e.g., a highly secret/confidential project). The computing device security settings may include one or more settings related to a frequency of grid authentication (e.g., periodically such as hourly/daily/never, event-driven such as when a new client is installed, each time the grid client “wakes,” etc.).

Grid Newsletter

User tools may include a grid newsletter, which may include the same or similar features as that described above with respect to the status indicator display and/or the grid screensaver. The information may be generated the same way and distributed as a page to display, in much the same way the displays discussed above may be generated. In one embodiment the information is compiled in the format of a web page or other HyperText Transfer Protocol (HTTP) file that can be viewed on the computing device. Thus, the grid newsletter tool can be accomplished by creating another view of the same data generated for the status indicator or screensaver. The enterprise software can implement a portal, which may be set up to display the above-mentioned data in a standard newsletter format. The newsletter can thus be generated automatically, and represent a snapshot of dyanamic data accessed, or provide a newletter distribution that includes mechanisms to automatically update the information on the newsletter each time the newsletter is accessed.

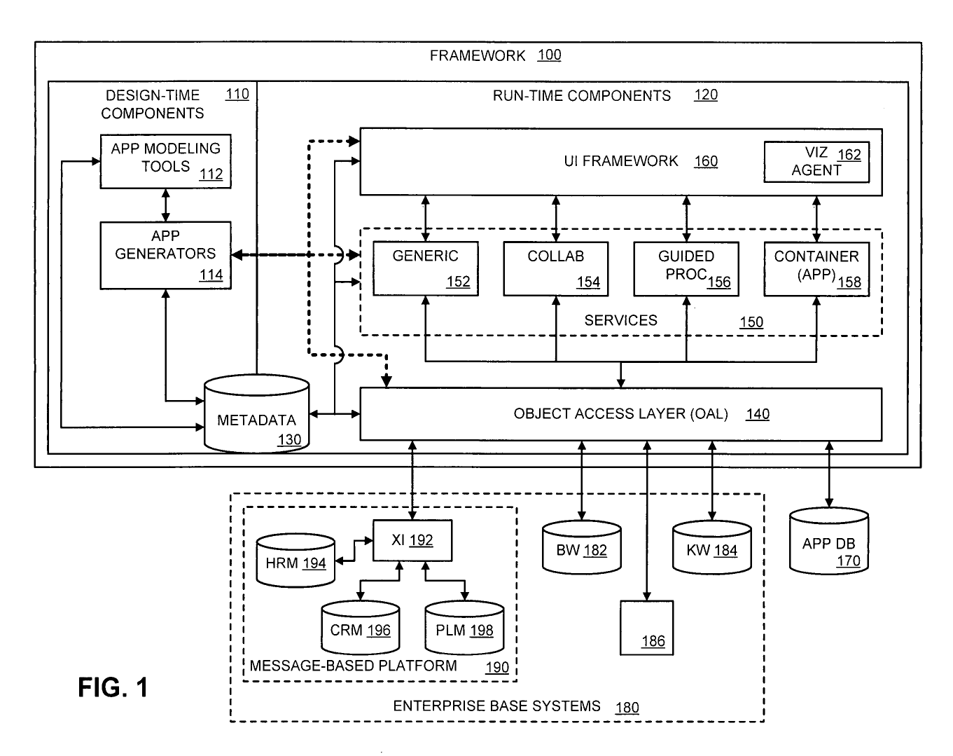

FIG. 1 is a block diagram of an embodiment of a composite application framework with a visualization agent. In general, framework 100 leverages and enhances underlying enterprise base systems 180, which could include one or more of a knowledge management warehouse (KW), a business (intelligence) warehouse (BW), an exchange interface (XI), supporting business transaction systems (e.g., customer relationship management (CRM), human resources management (HRM), product life-cycle management (PLM)), etc., with tools, content, and guidelines to provide a foundation for developing and executing composite applications.

Composite applications typically implement new or additional processes in an existing IT landscape, as opposed to the core transactional processes. Composite applications may also support semi-structured processes, handle event-driven and knowledge-based business scenarios, and/or support collaboration in teams. In one embodiment composite applications may support the JAVA stack. The composite applications may be broken down into various portions, each of which may be separately generated/modeled. The composite application portions may, in one implementation, be implemented as Enterprise Java Beans (EJBs), and in other implementations, the design-time components may have the ability to generate the run-time implementation into different platforms, such as J2EE, ABAP, or .NET.

Framework 100 may provide modeling and configuration tools (e.g., business object modelers, guided procedures), generic components (e.g., user interface (UI) patterns, generic services (functional key actions, help, authorizations)), standardized interfaces (e.g., object access layer), reusable content (e.g., predefined object models, XI content), and/or integration infrastructure (e.g., provide connections to business objects and/or documents, provide access to XI proxies). Framework 100 allows composite applications to be created according to guidelines, or documentation that allows composite applications to be created in a controlled and/or predictable manner. The guidelines may or may not be implemented in software.

Framework 100 may be implemented using readily available technology. For example, framework 100 could be implemented using mySAP technology components. In one embodiment the components may include an SAP WEB APPLICATION SEVER (WAS) to run applications, an SAP ENTERPRISE PORTAL to render applications, an SAP KW to handle unstructured information sources, an SAP BW to provide reporting and analytics, data mining, and planning and simulation, SAP BUSINESS PROCESS MANAGEMENT (BPM), an SAP Exchange Infrastructure (XI) to provide shared integration knowledge separate from applications, and/or SAP WEB SERVICES to offer business functionality over the Internet.

For instance, an SAP WAS may include a J2EE engine, SAP IDE, Universal Workflow, and Deployment Service. The WAS may also include a pattern-based and freestyle-based user interface development and interface module. Also, an SAP ENTERPRISE PORTAL may provide unified access to applications, information, and services by using views, roles, pages, worksets, top-level navigation, and KM. This enterprise portal also provides login management and user management. For KM, unstructured information consists of collaboration and content management. For collaboration, KM enables team-driven business processes, synchronous and asynchronous applications, groupware integration, calendars, bulletin boards, threaded discussions, and collaboration rooms. For content management, KM handles documents, feedback, rating, publishing, subscription, document workflow, versioning, archiving, indexing, searching, and taxonomies. SAP BPM may cover life cycles (e.g., design, development, deployment, and change). An SAP XI may provide external and internal integration of system and connectors to various systems such as ORACLE, SIEBEL, PEOPLESOFT, and/or SAP. The SAP XI may be based on Web services, JAVA, and XML standards. SAP Web services may provide a service provider, service handler, and service user. Additionally, an SAP BW may be used.

In one embodiment the KM and collaboration functionality may be embedded in applications, rather than, or in addition to being found in separate pages in the portal. Framework 100 supports development with any of a number of general development environments, for example, JAVA, with EJB (Enterprise JAVA Beans) 2.0, JDO (JAVA Data Objects), JAVA persistency, and/or JAVA application logic, Advanced Business Application Programming (ABAP), and Web services. Existing ABAP components may be integrated via JAVA connector calls. In one embodiment the complete JAVA stack could be used. Furthermore, Web service technology may be used for remote access.

In general, framework 100 allows composite applications to work with existing system landscapes, because framework 100 can decouple composite applications from the underlying enterprise platform. Decoupling may involve providing communication to back-end systems via a central interface and providing a back-end-independent object model. Providing a back-end-independent object model may be implemented to allow data from the source systems to be transformed into a unified structure. Transforming the data into a unified structure can further allow successive installation, activation, and use of different applications, which may reduce entry costs. Additionally, framework 100 facilitates highly efficient development of composite applications. Development of composite applications can be accomplished by model-driven composition of applications, service-oriented architecture, UI and application patterns, reusable object models, and methodologies. Thus, framework 100 could be viewed as a kind of application factory, which enables application building in part or in whole without programming.

Examples of the types of business processes supported by framework 100 include enterprise change management, product innovation, employee productivity, and enterprise service automation. Enterprise change management may support enterprises when merging, splitting, acquiring, spinning off, or reorganizing. Product innovation may support the life cycle of a product, including the preproduction phase(s) of collecting ideas and consolidating them into concepts, the market launch phase, and the end of life. In dealing with the life cycles of a product, the resources of a PLM and CRM may be drawn upon. Employee productivity aims to increase employee productivity, decrease costs, and increase employee satisfaction. Key functions may include manager self services, employee self services, expert finders, e-procurement, and e-learning. Enterprise resource management (ERM) and business to employee (B2E) resources may be drawn upon to accomplish these tasks. Enterprise service automation provides administration and monitoring functions as well as evaluation tools to facilitate project success, for example, as in the case of setting up a project and staffing the project with people having the required skills and availability to accomplish the project. Additional application families may also be created.

Framework 100 may also provide external services in a shared object environment, for example, by providing a uniform object access layer and service layer that bundle functionality across service components. Furthermore, a transparent mapping may be provided from the application's perspective. Thus, the application built on the framework would not have to know whether certain services are provided by a portal, by a KW, by a WAS, or other external service.

Framework 100 includes design-time components 110, run-time components 120, and metadata repository 130, which is shared by the design-time components and the run-time components. Metadata repository 130 represents an abstraction of one or more data and/or access/service resources design-time components 110 and run-time components 120 may draw on, and is not necessarily to be understood as a resource within one of the components, or available only to the components. In general, design-time components 110 are responsible for developing composite applications that are executed by run-time components 120.

Design-time components 110 provide a repository and user interface for modeling and generating business objects, business services, business processes, user interfaces, and/or other aspects/components of a composite application. A business object may be, for example, an employee, a product, a plant, or any other semantic representation of a real-world entity. A business service is an action taken on a business object. Changing the price or category of a product are examples of services for a business object that represents a product. As another example, gathering input from employees and customers (who may themselves be represented by business objects) for a new product idea could be considered a business service. Combining business services to allow the services to operate together, in sequence and/or in parallel or otherwise in conjunction, produces a business process. A composite application may include any number or combination of business objects, business services, and/or business processes.

Design-time components 110 include application modeling tools 112 and application generators 114. Design-time components 110 may draw on information from metadata repository 130. Modeling tools 112 represents one or more tools that may be used for modeling business objects, business services, business processes, user interfaces, etc. A separate modeling tool may be used for each portion/component/segment of a composite application. Additionally, a single modeling tool could provide functionality for multiple portions of the composite application. Furthermore, modeling tools 112 may be used for integrating business objects, business services, business processes, user interfaces, etc. Thus, framework 100 may support model-driven composition of composite applications, allowing for development with little or no programming effort.

In one embodiment application generators 114 allow template-based generation of JAVA-coding, database tables, entries in metadata repository 130, XML configuration files, etc. The template-based generation of information may be implemented with extensibility and the ability to conduct upgrades without loosing his information. The ability to implement with extensibility and upgradability can be achieved by allowing the metadata of the new implementation to be compared with the metadata of the existing implementation during an upgrade. If there are implementation-specific extensions, they may be identified, and strategies for solution of possible conflicts may be proposed.

Metadata repository 130 can include metadata about business objects, business services, business processes, and/or other application portions for use in modeling and/or executing the application portions. Thus, an application portion may be modeled, as well as the origin of the data, whether in a local database, remote database, or a combination of the two. In one embodiment the content of metadata repository 130 includes information extending beyond a specific implementation of an application portion. There could be repositories that describe a specific implementation, which may be filled from a more general repository. Metadata repository 130 can be understood as including a general, a specific, or a combination of repository information.

The metadata can enable generic services like automatic generation of default UIs, object access interface, data access methods, persistency, and mappings. Metadata repository 130 stores the content of the composite application (e.g., specific business objects, information about services, and, eventually, processes) and makes the metadata information available at run-time (if needed). Metadata repository 130 may allow different metamodels to be created (the model for business objects being one of them) and to persist the metadata. For specific purposes, additional repositories, such as, for example, a portal content directory (PCD), which may contain portal specific pieces of an application (e.g., views, pages, roles), may be required.

Application generators 114 generate source/executable code from the application portions modeled by modeling tools 112. Application generators 114 may include and/or use templates to generate the code. One or more templates may be stored, for example, in metadata repository 130. In one embodiment application generators 114 are driven by the metadata in metadata repository 130 to automatically create JAVA classes (e.g., for use in run-time components 120) and/or configuration files (e.g., to adjust user interface (UI) patterns to a certain business object). Thus, the connectivity to back-end systems and the application persistency may be generated, as well as a default user interface. Application generators 114 may also generate interfaces for application services, data access logic, and persistency.

Run-time components 120 provide the run-time environment for business objects, business services, business processes, user interfaces, etc., as well as data access abstraction. Run-time components 120 may include object access layer (OAL) 140, service layer 150, and a UI layer including UI framework 160 and visualization (viz) agent 162. Run-time components may draw upon the resources of metadata repository 130. In one embodiment run-time components 120 also use application database 170, which may store additional information for executing the composite applications. For example, application database 170 may store data tables for executing applications.

OAL 140 manages interaction between composite applications and enterprise base systems 180, and can provide a uniform interface for composite applications to enterprise base systems 180. Thus, OAL 140 can reduce the knowledge needed for a composite application developer about the source of data because OAL 140 sits on top of, and embraces different connectivity technologies. OAL 140 may act as a dispatcher to provide access to a variety of data sources. OAL 140 may leverage message-based platform 190, which may include XI 192 with connectivity to underlying applications. The underlying applications can include one or more of HRM 194, CRM 196, or PLM 198. OAL 140 can also leverage business intelligence warehouse (BW) 182 and/or knowledge management warehouse (KW) 184. In general OAL 140 provide connectivity to any underlying application/service, or enterprise base system, and may include some other application or service 186 not specifically described herein.

OAL 140 may also leverage a fairly synchronous infrastructure such as a service-oriented data access, which could be a BW, and a KW repository framework, which may allow connection to document management systems or to LDAP (Lightweight Directory Access Protocol), a more unstructured type of data. Thus, OAL 140 may bring structured and unstructured data closer together.

Coding and configuration data for OAL 140 may be automatically generated, at least in part, by business object metadata in repository 130. Furthermore, OAL 140 allows for local persistency (e.g., connectivity to a local database such as application database 170 to store data). Data synchronization and replication of remote data (e.g., data in back-end systems) into the local persistency database may be supported. For an application sitting on top of OAL layer 140, the source of the data may be completely transparent, which may assist in keeping application logic stable since the application is, at least for the most part, not affected by underlying systems. In one embodiment OAL 140 includes extensions to document management or content management that allow business objects to use the functionality for documents.

In one embodiment OAL 140 includes extensions to document management or content management that allow business objects to use the functionality for documents. For example, taxonomies for business objects, transparent indexing of TREX for structured and unstructured objects, and subscription services for dependent objects independent of the repository where the objects reside may be provided. OAL 140 may also provide transaction support, in as far as the transaction concept is also supported by concerned source systems, a metadata interface, allowing an application to be dynamically configured at run-time, and subscription services (e.g., J2EE publish and subscribe).

OAL 140 may have a variety of features, for example, by making the origin of data transparent to the application logic and UI to keep the application logic and UI stable. Thus, there may be little to no impact of the underlying information technology (IT) system landscape on the application logic or UI, because OAL 140 handles adaptation to the specific landscape. Furthermore, the abstraction provided by OAL 140 can prevent changes to enterprise base systems 180, such as KW and XI, from having a direct influence on the application logic or the UI. Thus, the underlying functionality may be changed without affecting the application logic or overall user interface experience.

Additionally, OAL 140 may accelerate composite application development. In one embodiment business objects are reused across composite applications, avoiding redevelopment of functions already developed, and potentially avoiding the need to port to a new environment. Example of reuse and development acceleration may include reusing enterprise base systems 180 access services (e.g., KW, XI) across composite applications, reusing know-how (e.g., uniform interface structure providing common access to business objects), efficient (e.g., model-driven) implementation of business objects based on a repository, and/or using a relative homogenous structure for application logic, which simplifies modifications and maintenance.

Additionally, OAL 140 may enable integration. Integration may be facilitated by communication between composite applications via a shared object model, shared contexts across composite applications based on a shared object model, and integration of enterprise base system (e.g., KW and BW) via a composite application object model. The integration may also involve integrating business objects.

Additionally, OAL 140 may facilitate application building by configuration. Application building by configuration can be accomplished by providing standard interfaces with well-defined semantics, which allows components to be combined in a meaningful way since the semantics of the components' interfaces is known, and allowing objects to participate in a collaborative context, (e.g., chat room) just by implementing certain interfaces.

Service layer 150 provides services for business objects in OAL 140. In general, services for business objects are common procedures that users need to interact effectively with the objects. Service layer 150, for example, may include generic services 152, collaboration services 154, guided procedure services 156, a container for application services 158, and/or other services not depicted in FIG. 1. Thus, a service layer 150 may be more or less complex than what is shown, and may include multiples of a particular type of service, and other services not shown. By separating the services from the business objects, the services may be more readily reused across business objects. In one embodiment service layer 150 provides integration of external services.

Generic services 152 provide one or more standard services for parts of an application. A standard service may refer to traditional services, as well as services that are useful to more than one application. Generic services 152 may also provide namespace and packaging concepts. Generic services 152 are typically not bound to a portion of an application, but are available to all portions. Examples of generic services 152 include print services, value help services, authorization, personalization, and voice enablement. An example of a value help service is the filling of drop down boxes in user interfaces; the service is able to determine what the possible entries are for boxes and to populate the boxes therewith.

Collaboration services 154 represent one or more services to provide the ability to link semantic objects to business objects. Semantic objects typically provide a set of generic services, like classification, notification, subscription, feedback, search, retrieval, rating, time-based publishing, state-based publishing, and security model. In addition, relations between semantic objects may be supported. For example, a team could be assigned to a task, and people could be assigned to the team. Moreover, a room could be created for the task, to keep people and documents together. Semantic objects such as document, folder, room, task, meeting, user, and discussion may be accessible via OAL 140. Semantic objects may also be available in a variety of other ways. For example, semantic objects may be included in OAL 140 as business objects and/or service, and/or individual services of semantic objects may be included in service layer 150.

Collaboration services 154 extend the semantic object concept by making the functionality of semantic objects available for business objects (e.g., notification, subscription, etc.). Thus, collaboration services 154 provides collaboration context for a business object. Collaboration services 154 may automatically manage the relations between business objects and semantic objects. In addition, new kinds of relations may be supported: for example, relations between business objects and semantic objects. Thus, a task or a team may be assigned to a specific product, people may be assigned to the task, and so on. Furthermore, special collaborative services may be provided for semantic objects, such as scheduling and assignment functions for tasks and inviting, splitting, and closing functions for discussions. In particular implementations, a suite of collaboration services may be provided without the need to deal with KM specific. These services may also be made available for composition applications. Furthermore, the relation between the business objects and the semantic objects may be maintained. The collaboration provided by collaboration services 154 may be semi-structured processes. A common understanding of a business process may be reflected by a predefined collaboration scenario. On the other hand, the business process may be adaptable to different enterprise's needs. To support this, differing scenarios may be built with minimal programming.

Guided procedure services 156 allow business objects to participate in guided procedures. A guided procedure is a series of steps, which may involve human interaction and can be performed during the execution of a composite application. A guided procedure may be considered to be a type of workflow. A guided procedure may be common to a variety of applications and, thus, may be reused. To provide guided procedures, guided procedure services 156 may provide pre-defined building blocks for process workflow and pre-defined actions. Additionally, guided procedure services 156 may facilitate template design. This may be used to support role-based collaborative processes, process workflow, and/or context definition. At run-time, guided procedures may be implemented by using template instantiation, by design-time integration for ad hoc adaptation of templates, and procedural navigation and integration in a Universal Worklist (UWL). Furthermore, guided procedure services 156 may provide context awareness and sharing by context mapping of building blocks, business object integration, and user assistance. Additionally, guided procedure services 156 may provide monitoring and analysis of guided procedures.

Application services container 158 can be used to implement model specific services for one or more business applications. Although generic objects, generic services, and/or processes may be generated for an application, some business logic is too specific to be implemented generically. For example, determining the number of vacation days that an employee has may involve determining the number of vacation days the employee is entitled to per year, determining the number of days available based on the employee's service to date for the year, determining how many days the employee has been absent to date for the year, and determining whether to assign those days to vacation days or sick days. Furthermore, if the employee is splitting time between departments, an allocation may need to be made between the two. As another example, an order process at a manufacturer may include obtaining an order, splitting the order into components based on the bill of materials, determining whether each component is in stock, if a component is not in stock, determining where and/or how to procure it, and, if a component must be procured, determining a potential delivery date. The business logic for such tasks may be difficult to model generically, especially across a wide variety of industries. Thus, the logic may be specifically coded to the specific task(s). Container for application services 158 provides one or more interfaces for the task-specific code to be used. The interfaces may be generated by the metadata of the service model, with the inner code individually or specifically programmed for the particular task. Also, maintaining the service definition in the design-time allows generation of an empty service.

The UI layer includes UI framework 160 and visualization agent 162, which will be discussed briefly here, and in more detail below. UI framework 160 provides user interfaces that allow a user to interact with composite applications. In particular implementations, UI framework 160 provides pattern components, such as, for example, a dashboard, a search bar, a browse and collect function, an object editor, and phases for a guided procedure, as building blocks for user interfaces. UI framework 160 may also decouple application logic from the UI, for example, by having a separation of the business objects of OAL 140 and application services of services layer 150, from the user interface elements of UI framework 160. The separation or decoupling can provide for the reuse of UI components in different application contexts. The decoupling can also enable business objects and application services to be visualized differently according to the specific equipments of a certain use case.

In one embodiment UI framework includes visualization agent 162 to provide visualization and/or other presentation of data/information and/or service options to a user. Visualization agent 162 may generally be described as providing the combinations of various presentation methods based upon the various navigation, working context, and/or data types, as described above. Additionally, visualization agent 162 may provide services to enable the presentation of thumbnail representations of various business processes, including structure and status of the processes. In one embodiment the thumbnail representations further include mechanisms to allow drilling down to additional information related to the process, and/or the process itself.

UI framework 160 may also leverage the metadata information on business objects and services through metadata-driven UI-generation and configuration. The metadata approach allows for ready adaptability to alternative screens depending on the end users needs (e.g., in different industries). UI framework 160 may additionally allow integration (e.g., binding) into OAL 140 to access business objects, business services, and metadata. Thus, UI components may be connected to business objects or other base systems through OAL 140. UI framework 160 may support any appropriate type of user interfaces, such as, for example, a user interface composed of pattern-based components and/or freestyle components with interfaces to the user interface components or JAVA SERVER PAGES (JSPs) from SUN JAVA SERVER PAGES (JSPs) available from SUN MICROSYSTEMS, INC., of Santa Clara, Calif. UI framework 160 may also support a JAVA front-end and ABAP back-end, a JAVA front-end and JAVA back-end, or any other appropriate combination of front-end and back-end. The framework may additionally provide a construction kit for complex components and applications and configuration of patterns via XML, URL, or other appropriate technique.

Framework 100 may be connected to application database 170, which may provide a central repository for available business objects. An example of data in application database 170 includes database tables for a business object. The data may be added to, changed, and/or deleted. Data may also be stored in KW, BW, or an XI system. As discussed, framework 200 provides a set of standard services that enables application developers to make use of the data. The origin of the data and/or its persistency may be transparent to the application developer, not to mention the composite application.

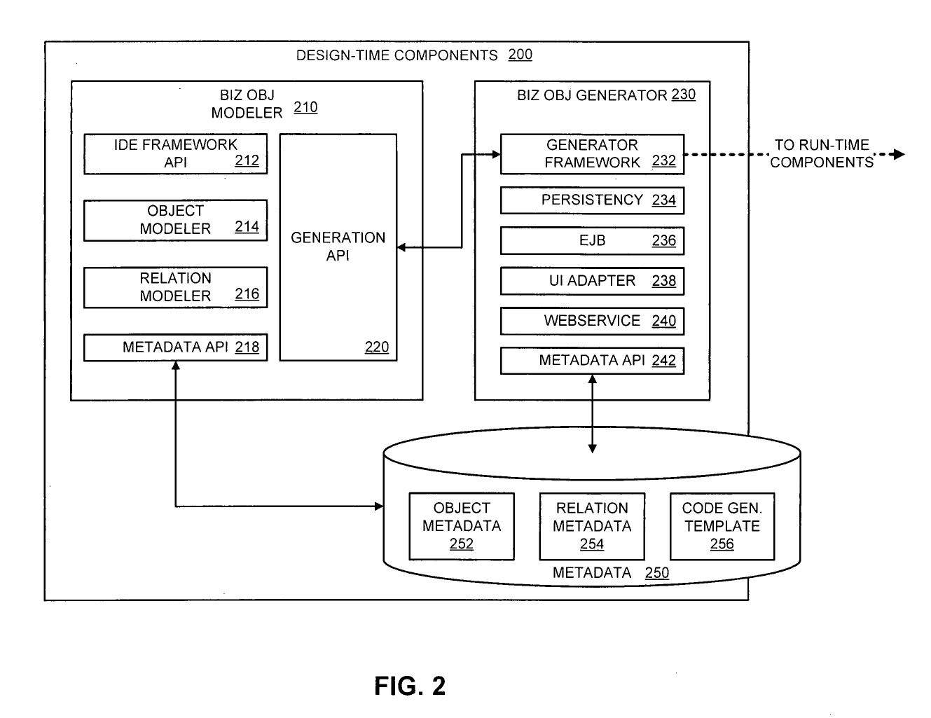

FIG. 2 is a block diagram of an embodiment of design-time components of a composite application framework. Design-time components 200 provide one example of design-time components 110 of FIG. 1. Design time components 200 include business object modeler 210, business object generator 230, and metadata repository 250. Metadata repository 250 can also be considered, at least in part, a run-time component.

Business object modeler 210 may include various components, for example, Integrated Development Environment (IDE) framework application program interface (API) 212, object modeler 214, relation modeler 216, and metadata API 218 to access metadata repository 250. Fewer components than what are shown may be included in one embodiment of the invention, and more complex variations are also possible, including components not necessarily shown. IDE framework API 212 allows object modeler 214 to be integrated into an IDE (e.g., an ECLIPSE IDE), which supports the modeling of the business object by object modeler 214. For example, the integration may support generation of business objects as EJBs, interfaces for application services, default user interfaces, data access logic, and persistency. Relation modeler 216 allows the modeling of relations between modeled objects. For example, a sales order could consist of a customer, a product, and a price. Relation modeler 216, therefore, could provide for the modeling of the relations between these items. In operation, for instance, if a user interface is generated for a sales order, the semantics for each field in the sales order may be identified. Additionally, a connection to the value help function may be facilitated. Metadata API 218 enables business object modeler 210 to store and access business object metadata in metadata repository 250 and relation modeler 216 to store and access business object relation metadata in metadata repository 250.

Business object modeler 210 also includes generation API 220, which allows a business object to communicate with generator framework 232 for code generation, and providing the generated code to a run-time environment.

Business object generator 230 can include generator framework 232, persistency generator 234, EJB 236 generator, UI adapter generator 238, Web service generator 240, and metadata API 242. Generator framework 232 may also be integrated into the IDE accessed through IDE framework API 212.

To generate a business object, business object generator 230 may use templates in metadata repository 250 and code them with object metadata and relation metadata in the repository. Business object generator 230 may also generate the data persistency for the business object, and generate the actual business object (e.g., an EJB). Business object generator 230 may additionally generate user interfaces for the business object and any necessary Web services. Templates used by business object generator 230 may be generic. In one embodiment the various generation components automatically create JAVA classes (e.g., for the implementation of the object access layer), JDO tables, EJBs, and configuration files, to adjust UI patterns to a certain business object, for example. Thus, the connectivity to back-end systems and the composite application persistency is generated as well as a default User Interface. Furthermore, UI adapters for a UI development and interface module and, if necessary, Web services may be generated. The output of such a process may be real working code in the object access layer of the run-time components.

In one example, business object generator 230 generates a run-time implementation of a business object in an object access layer. Business object generator 230 reads the business object metadata from metadata repository 250 and generates JDO persistency, connectivity to an XI, a KW and/or a BW (e.g., by using proxies), generates generic methods, and a basic UI. For this coding, templates (e.g., for services) or XML-templates (e.g., for JDO persistency) are used where business object specific coding or XML is added, and the result is stored as complete code or complete XML.

Metadata repository 250 may include various items of data, including, but not limited to, object metadata 252, relation metadata 254, and code generation templates 256. The information in object metadata 252 and relation metadata 254 may be used to code templates 256 to generate a business object.

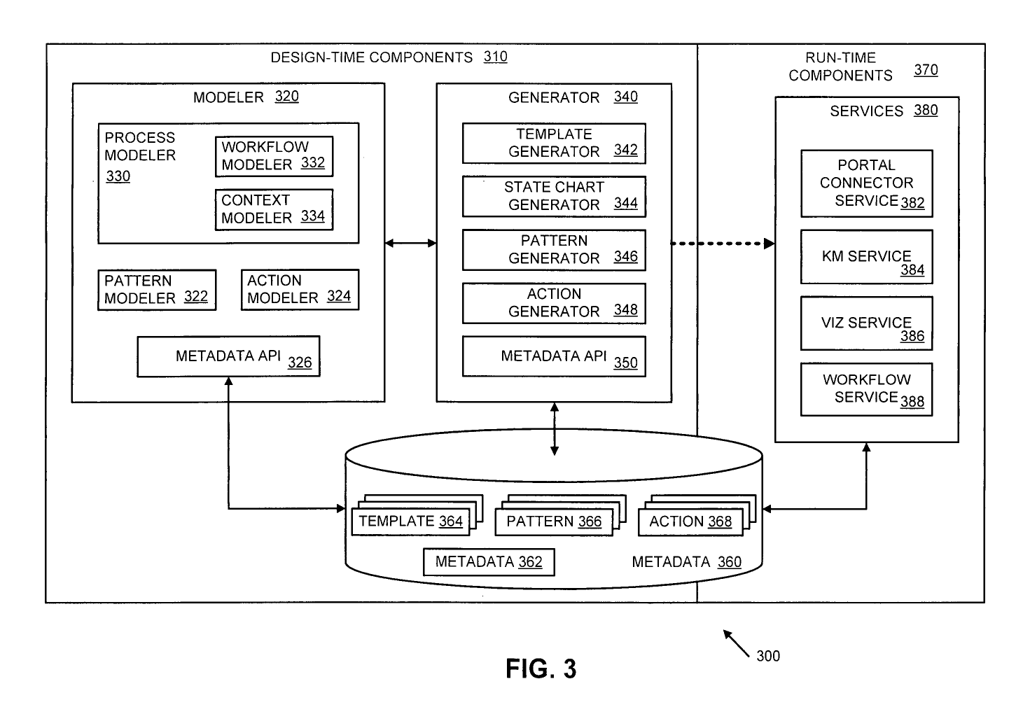

FIG. 3 is a block diagram of an embodiment of guided components for a composite application framework. As mentioned previously, a guided procedure is a series of operations/functions/performances, which may involve human interaction, which can be performed during the execution of a composite application. A guided procedure may be common to a variety of applications. Components 300 may be classified into design-time components 310 and run-time components 370. Metadata repository 360 may be part of and/or interact with both design-time components 310 and run-time components 370. Design-time components 310 may be used to generate run-time components 370. Design-time components 310, run-time components 370, and metadata repository 360 are examples of similarly-named components described previously.

Design-time components 310 include modeler 320 and generator 340. Modeler 320 includes process modeler 330, pattern modeler 322, and action modeler 324. Process modeler 330 includes workflow modeler 332 and context modeler 334. Workflow modeler 332 allows process workflow for a guided procedure to be modeled, and context modeler 334 provides context definition. That is, context modeler 334 allows relations between other processes to be defined. For example, an application may have more than one way of being activated, for example, Intranet Web-based form versus remote voice control. Context modeler 334 can provide for both activation mechanisms to be associated with the application. Pattern modeler 322 provides workflow patterns (e.g., delegation, approval) for workflow modeler 332, and action modeler 334 provides actions for workflows. Modeler 320 also includes a metadata API 326, which provides access to the data in metadata repository 360. Thus, access to metadata regarding guided procedures can be provided.

Generator 340 includes template generator 342, state chart generator 344, pattern generator 346, action generator 348, and metadata API 350. In one embodiment templates describe a workflow that may be may be implemented using workflow patterns. Workflow patterns may contain actions that define the workflow and therefore, part of the template. Thus, a pattern may be viewed as an abstraction of an action, and a template may be viewed as an abstraction of work flow pattern. For example, a template could describe a workflow for ordering a product (e.g., a computer). The template may specify a workflow pattern for obtaining manager approval. The pattern could have certain actions that need to be undertaken to complete the workflow. An example of an action could be finding the names of the employee's managers. The approval pattern, moreover, could be used for different templates.

Template generator 342 generates templates, state chart generator 344 generates state charts, pattern generator 346 generates patterns, and action generator 348 generates actions for the run-time environment. Metadata API 350 provides access to the metadata in metadata repository 360. Metadata repository 360 can include one or more templates 364, one or more workflow patterns 366, one or more actions 368, and/or other metadata 362. The templates, patterns, actions, and metadata may be accessed by generator 340 to produce a guide procedure. Other information may be found in metadata repository 360, and metadata repository 360 does not necessarily include all the items represented in the figure in all embodiments.

Run-time components 370 provide instantiation for guided procedures, producing instances of application portions. In one embodiment procedural navigation and integration may be provided in a Universal Worklist (UWL). Run-time components 370 may include various services, for example, portal connector service 382, KM service 384, visualization service 386, and/or workflow service 388. The services depicted in FIG. 3 are merely representative, and are not to be understood as necessary or restrictive of the type of services possible. For example, run-time components 370 could also include one or more of object access services, context sharing service, content services, and metadata services.

Object access services can allow objects in an object access layer to be accessed. Context sharing service can provide context to a workflow. For example, when a user accesses a workflow, a context sharing service can provide a link to the proper portions of the workflow. For instance, many workflows involve inboxes, where new tasks for the workflow may be sent. The inbox may provide a link to the proper portion of the workflow if the context is known. Content services can provide services for executing functions based on generic calls. For example, a workflow may need an application (e.g., a composite application, an HRM application, a CRM application) to be initiated. By making a generic call to content services, the application may be initiated. Content service may support integration with an application and/or a user interface.

Portal connector service 382 can provides a connection service to a portal. KM service 384 can provide a connection service to a KM module. Visualization service 386 can provide functionality to a visualization agent. For example, various combinations of visualization and/or other presentation of data may be possible based on a work mode of a user. In another example, information may be presented to a user to provide iconic views of one or more business processes, including status and structure. The manner in which the data and interaction of the various services for the user is made can be controlled/managed via one or more visualization services 386. Workflow service 388 can provide a connection service to an ad-hoc workflow. This workflow may be very user-centric, allowing the assignment of not only tasks handled by transactions in business systems, but also tasks that require user handling (e.g., compose e-mail).

Components 300 may have a variety of features. For example, the components may provide context mapping for building blocks, and a user profile may be automatically used and updated. In certain implementations, ad-hoc administrations of running workflows may be supported and guided procedures may be monitored and analyzed.

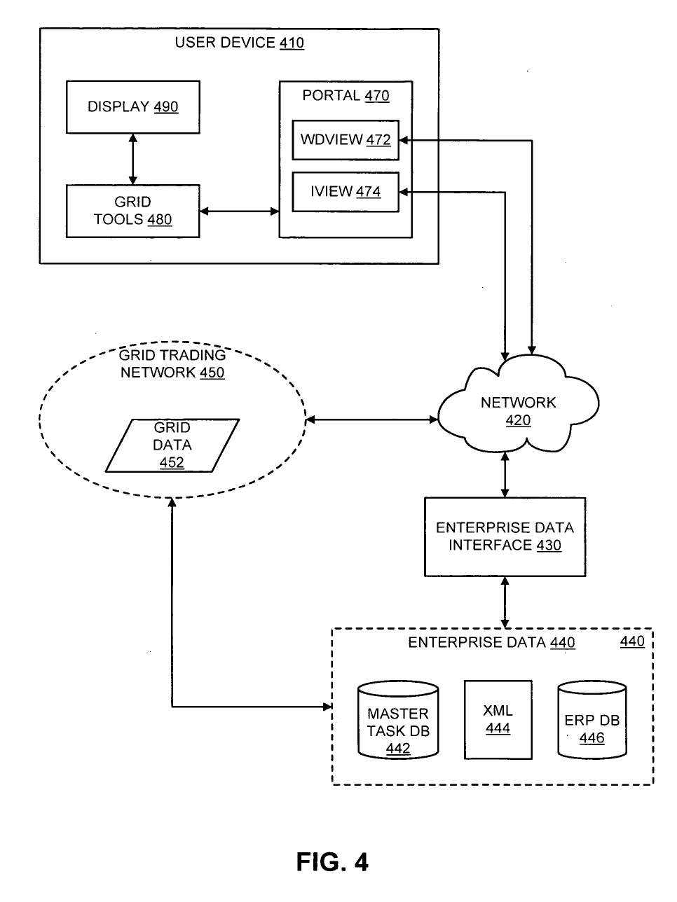

FIG. 4 is a block diagram of an embodiment of a user device with grid tools and a portal interfaced with enterprise and grid processing network data. User device 410 may be any computing device discussed above. User device 410 includes display 490, which may be a LCD (liquid crystal display) display, TFT (thin film transistor), CRT cathode ray tube, touchscreen, etc. In one embodiment display 490 includes one or more grid tools 480, which represent grid tools as described above. Grid tools 480 may place information on display 490, render a WebDynpro page on display 490, provide interactive links viewable on display 490, etc. Grid tools 480 may be generated by, or may include, or may be one or more portals 470. Portal 470 provides a controllable access point over network 420 to an enterprise network and/or grid trading network 450.

Portal may include one or more WebDynpro (WD) Views 472, which represent the access functionality of portal 470 to interface with network 420 and retrieve information, even dynamic data, access data objects, send information or commands to the enterprise or grid trading network 450, etc. WebDynpro View 472 represents a technology for interfacing the enterprise/grid, and should not be understood as limited to one particular implementation. In one embodiment WebDynpro Views 472 interact with a single data object. In one embodiment iView 474 is used in addition to or in place of a WebDynpro View. iView 474 can provide similar functionality as WebDynpro View 472.

To access the enterprise network and enterprise data 440, WebDynpro View 472 may interface with enterprise data interface 430, which represents one or more components, software and/or hardware, that provide enterprise network services and data access (e.g., an enterprise server). Enterprise data 440 may include one or more of master task database (DB) 442, XML (extensible markup language) element 444, ERP (enterprise resource planning) database 446, and/or other elements of data or data objects. Grid data 452 may be accessed through enterprise resources, or over the enterprise framework. Thus, in one embodiment grid data 452 could be considered part of enterprise data 440, because the data is accessible just as other enterprise data 440 is accessible. The similar access may make grid data 452 indistinguishable from enterprise data 440 as far as user device 410 is concerned.

User device 410 may access grid trading network 450 over the framework of network 420, which may be an enterprise LAN. In one embodiment WebDynpro Views 472 may be considered to obtain grid data 452 directly from grid trading network 450. Grid tools 480 may include functionality to monitor and/or otherwise access grid data 452 through portal 470.

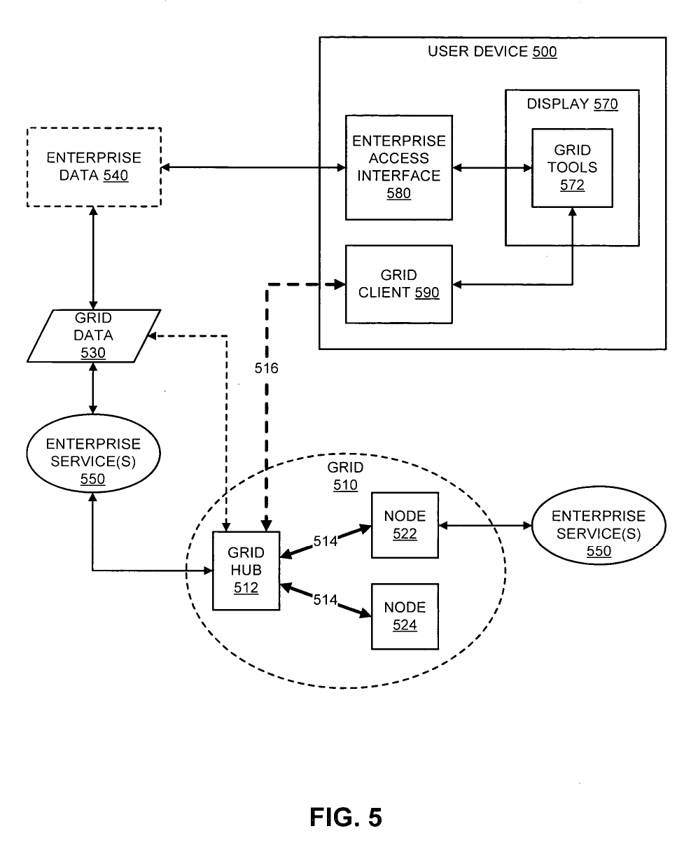

FIG. 5 is a block diagram of an embodiment of a user device with grid tools having access to grid data. Grid 510 represents a grid processing network, or grid trading network. Grid 510 includes several entities, including grid hub 512 and one or more nodes 522-524. Grid hub 512 represents a master node, a control node, a distributing node, or other comparable entity. In one embodiment grid hub 512 is dynamic in that any node of grid 510 may be the hub at one point or another. Grid hub 512 performs the distribution of operations for one or more problems. Different nodes may distribute the operations associated with different problems to be solved by the grid. Grid hub 512 includes links 514 to nodes 522-524, which represents one or more communications links and connecting/interfacing hardware to enable grid hub 512 to communicate with node 522-524. Links 514 are not necessarily local links, although they may be. Links 514 could extend across departments, cities, even continents. Nodes 522-524 represent computing devices that participate in grid 510 by performing work for the grid. Data can be exchanged on grid 510 over links 510. Note that nodes 522-524 may also be interconnected with one or more links similar to link 514.

Grid 510 may generate data, or data may be generated about or related to grid 510, which is all represented in grid data 530. Grid data 530 may include information regarding participants in the grid, problems being worked on or solved by the grid, progress made by the grid, or other information. Grid data 530 may be provided or generated by grid hub 512. In one embodiment grid hub 512 and/or one or more node 522 may use enterprise service(s) 550. Enterprise service 550 represents one or more functions or services provided by the enterprise framework, and may include information gathering, dissemination, and/or storage, access and interconnecting services, external network access services, business process execution, etc. One or more enterprise services 550 may be directly related to operations performed on grid work. In one embodiment enterprise service 550 provides a framework and repository for generating and storing grid data 530, which may or may not be considered to be part of enterprise data 540, or may be accessible through access to enterprise data 540 by user device 560.

Grid data 530 may be generated by the hub, gathered at the hub, or simply passed by the hub to the enterprise, as in making grid data 530 part of enterprise data 540. An enterprise server may have one or more services for generating, gathering, and/or passing grid information. Grid data 530 may be presented to the enterprise or one of its clients/users through some sort of enterprise service 550, such as might be found on an enterprise server.

In one embodiment user device 560 is a node of grid 510, with link 516 to grid hub 512 for receiving processing tasks, returning information, and/or for generating and reporting results/information. Grid client 590 represents one or more modules present on user device 560 that provide interaction with grid 510. Grid client 590 may be triggered to activity and/or restricted from one or more activities based on settings on user device 560 regarding grid access, security, and use settings. The settings and other access tools may be present in grid tools 572. Grid tools 572 may be presented to the user of user device 560 through display 570.

User device 560 may receive information about grid 510, and especially information specifically about its own participation. Grid data 530 and enterprise data 540 may include information obtained by enterprise access interface 580 and/or grid client 590 to display on display 570 with grid tools 572. User device 560 may also obtain information about the participation of one or more of nodes 522-524, including potentially a comparison of the participation of the various computing device.

In one embodiment grid 510 may run on the enterprise network, at least in the sense that one or more nodes in grid 510 may be part of the enterprise or otherwise utilize enterprise services 550. Thus, in one embodiment grid client 590 and grid tools 572 are special cases of enterprise access modules and enterprise access tools that have controllable interfaces to allow a defined relationship between grid 510 and user device 560.

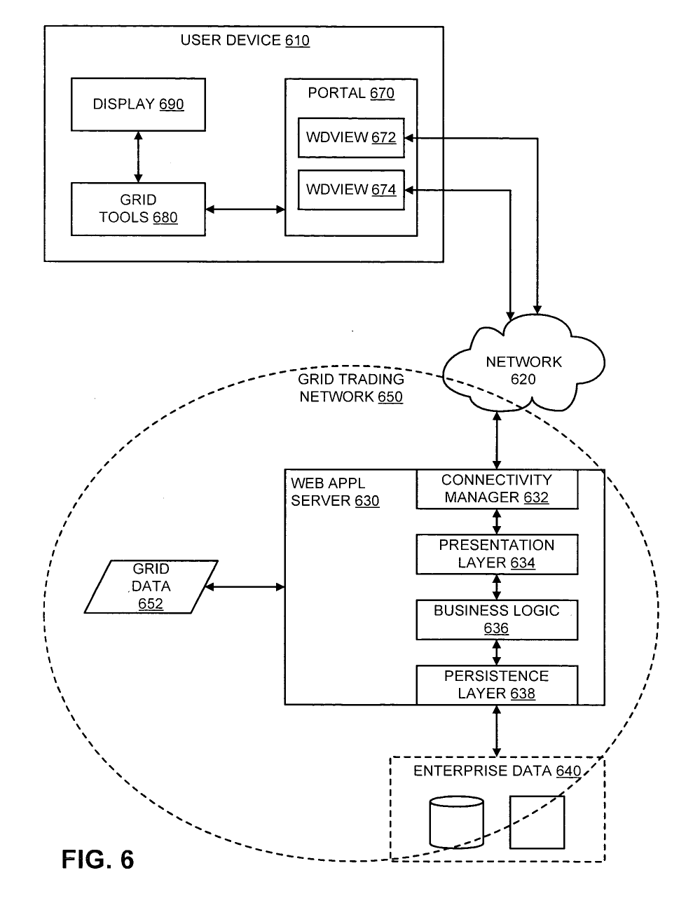

FIG. 6 is a block diagram of an embodiment of a user device with grid tools and a portal interfaced with a grid trading network. User device 610 may be a user device similar to any embodiment previously mentioned, with portal 670 having WebDynpro Views 672-674, grid tools 680, and display 690. A description of these items is set forth above with respect to FIG. 4. User device 610 is coupled to grid trading network 650 over one or more network interfaces, including portal 670, over network 620. Network 620 represents one or more hardware and/or software elements that enable user device 610 to interconnect with other devices. All or part of network 620 may be included within grid trading network 650. In one embodiment user device 610 could also be considered to be “within” grid trading network 650, from the perspective that user device 610 is a participant in the network.

User device 610 may be coupled to Web application server 630, which represents one mechanism capable of providing interconnection services or enterprise services, and in one embodiment represents a WAS (WEB APPLICATION SERVER) available from SAP AG. Although the structure of Web application server 630 may differ with various implementations, in one embodiment Web application server 630 includes connectivity manager 632, presentation layer 634, business logic 636, and persistence layer 638.

Connectivity manager 632 may include an Internet communication manager, and may couple to external applications and/or an exchange infrastructure to enable providing services associated with disparate systems. Connectivity manager 632 may provide a connection to portal 670, a browser, or another interface of user device 610. Connectivity manager 632 may operate with, or employ any of a variety of protocols, including, but not limited to HTTP (HyperText Transfer Protocol), SMTP (Simple Mail Transfer Protocol), SOAP (Simple Object Access Protocol), UDDI (Universal Description, Discovery and Integration), RFC (Remote Function Call), FTP (File Transfer Protocol), etc.

Presentation layer 634 may provide information to user device 610 for display on display 690. Presentation layer 634 may employ any of a number of techniques described in above-referenced U.S. patent application Ser. No. 11/181,644 [Attorney Docket 6631.P038]. Business logic 636 provides capabilities to Web application server 630 to provide the infrastructure for connecting user device 610 to devices and services to enable aspects of grid network participation as described herein. Presentation layer 634 and/or business logic 636 may be enabled by JAVA technologies and/or ABAP (Advanced Business Application Programming) technologies.

Persistence layer 638 can provides database or data abstraction, coupling user device 610 and potentially other devices to enterprise data 640. Persistence layer 638 may include connection, management, and/or caching capabilities.

Web application server 630 may also receive and forward grid data 652 to user device 610, and/or pass data from user device 610 to one or more entities on grid trading network 650.

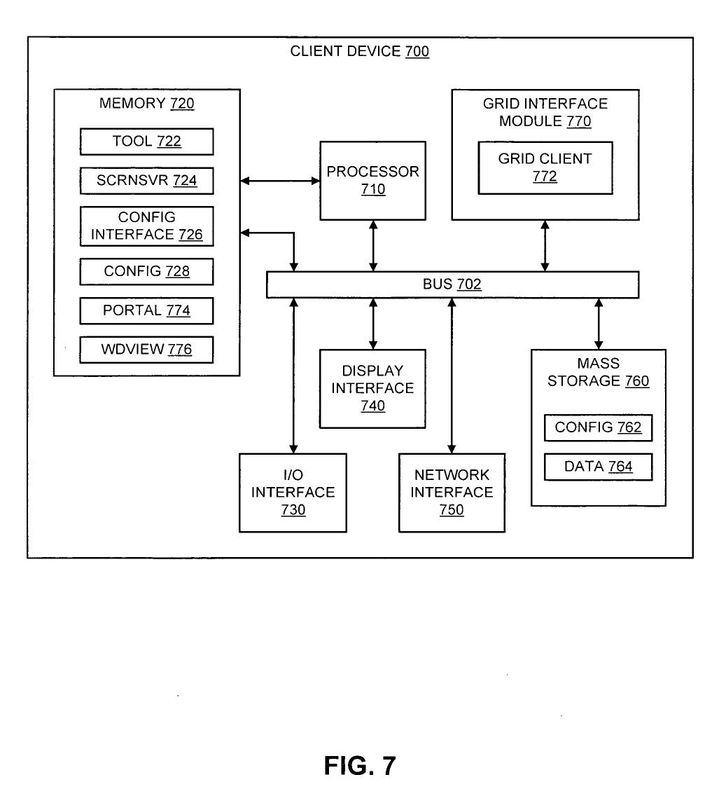

FIG. 7 is a block diagram of an embodiment of a client device with a grid interface module. Client device 700 provides an example of a computing device, as discussed herein. Client device 700 includes one or more processors 710, and memory 720 coupled to processor 710. Processor 710 may include any type of microprocessor, central processing unit (CPU), processing core, etc., suitable for executing the functions of client device 700 within the performance criteria determined for the system design, including obtaining and displaying grid data. Processor 710 controls the overall operation of client device 700, and may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

Memory 720 represents the main memory of client device 700 to provide temporary storage for code or data to be executed/operated on by processor 710. Memory 720 may include read-only memory (ROM), flash memory, one or more varieties of random access memory (RAM), or the like, or a combination of such devices or technologies. Examples of programs or applications, or routines or sub-parts of an application present in memory 720 may be tools 722, screensaver 724, configuration interface 726, configuration settings 728, portal 774, and WebDynpro View 776.

Processor 710 and memory 720 are coupled to bus system 702. Bus system 702 is an abstraction that represents any one or more separate physical buses, communication lines/interfaces, and/or point-to-point connections, connected by appropriate bridges, adapters, and/or controllers. Therefore, bus system 702 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”).

Also coupled to processor 710 through bus system 702 are one or more input/output (I/O) interface(s) 730, which represent mechanisms for interacting with a user, one or more display interface(s) 740, which represent mechanisms for providing a visual display of information, one or more network interface(s) 750, which represent mechanisms to connect to a network, a grid, and/or an enterprise network, and one or more mass storage mass storage device(s) 760. I/O interface 730 may include audio I/O, data and cursor control (e.g., keyboard, mouse), etc. Display interface 740 may include a monitor or screen display. Network interface 750 may be, for example, a twisted wire port (e.g., Category-5 cable), an Ethernet adapter, etc. Mass storage 760 may be or include any conventional medium for storing large volumes of data in a non-volatile manner. Mass storage 760 may hold data/instructions in a persistent state (i.e., the value is retained despite interruption of power to client device 700), which may include code and/or data 764, and configuration settings (config) 762.

As described above, many services or tools may be present in memory 720. Tool 722 represents a general tool or function, including a display tool to provide status indication and interactive grid information in a display. Screensaver 724 may display grid information in an idle period of client device. Configuration interface 726 allows grid interface module 770 to provide settings for one or more components or other software/hardware modules. Configuration settings 762 may include settings regarding the security parameters or grid participation parameters or other information related to how client device 700 is defined to interact with a grid network. Portal 774 provides access to an enterprise network and its data and/or a grid and its data. Memory 720 may include one or more WebDynpro Views 776, which may be included with portal 774, and which represents an application or function that accesses data and provides it for display on client device 700. Display interface 740 can interact with any or all of these tools as well as grid interface module 770 to present information, objects, links, etc., to a user.

Grid interface module 770 provides the functions for accessing grid data from the enterprise or some other network, and presenting the information to client device 700 through display interface 740. Grid interface module 770 may include one or more grid clients 772, which may be software or other modules provided by the grid to perform operations or other grid services. Grid interface module 770 can exist independently of the other components of client device 700, or may represent services/functions available from one or more components of client device 700. Grid interface module 770 may be coupled to other software or hardware components of a host computing device. Coupling to software components may be through the use of application program interfaces (APIs), for example, function calls, etc. Coupling to hardware components may include wireless or wired communication links, electrical or optical interfaces, etc.

Grid interface module 770 may include hardware, software, and/or a combination of these. In a case where module 770 includes software, the software data, instructions, and/or configuration may be provided via an article of manufacture by a machine/computing device/hardware. An article of manufacture may include a machine accessible/readable medium having content to provide instructions, data, etc. The content may result in a computing device, as described herein, performing various operations or executions described. A machine accessible medium includes any mechanism that provides (i.e., stores and/or transmits) information/content in a form accessible by a machine (e.g., computing device, electronic device, electronic system/subsystem, etc.). For example, a machine accessible medium includes recordable/non-recordable media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. The machine accessible medium may further include a computing device having code loaded on a storage that may be executed when the computing device is in operation. Thus, delivering a computing device with such code may be understood as providing the article of manufacture with such content described above. Furthermore, storing code on a database or other memory location and offering the code for download over a communication medium via a propagated signal may be understood as providing the article of manufacture with such content described above.

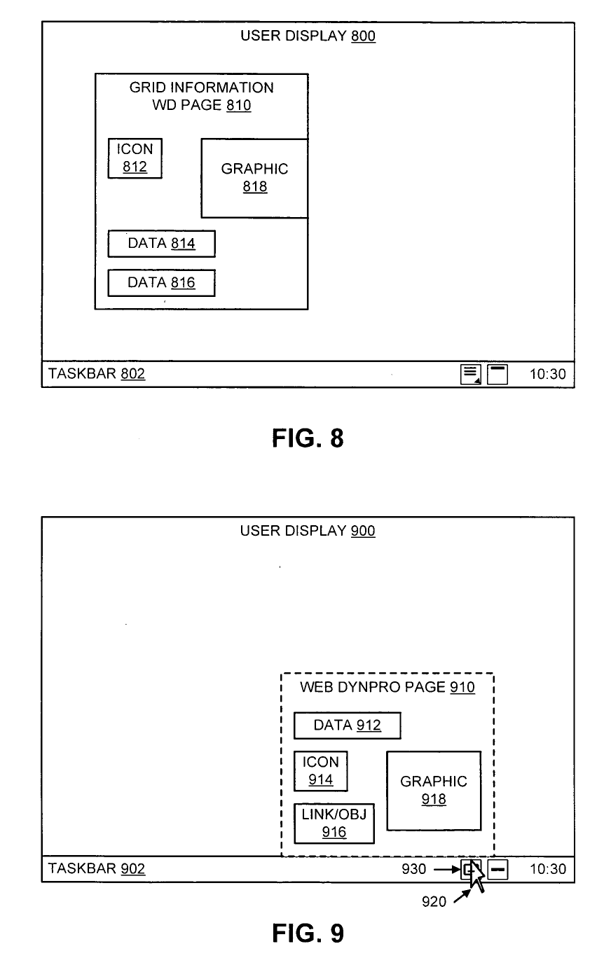

FIG. 8 is a block diagram of an embodiment of a user display with grid data. User display 800 may be a display on a user computing device, as previously described. User display 800 may include grid information WebDynpro (WD) page 810 that displays grid information. WebDynpro page 810 can contain any type of data, information, message, object, link, etc. Some of the items in WebDynpro page 810 may be merely informational, while some will be interactive and allow access to a process, service, or function as with business objects or enterprise data. In one embodiment user display 800 includes taskbar 802, which may include task icons and/or a time, date, etc.

WebDynpro page 810 can be generated as discussed above, through the use of the described display interface, or rendered with portals and/or WebDynpro Views overlaid on the generated display. Display may include graphic 818, which can display charts or graphs, or other visualizations to convey grid information, including topologies. Graphic 818 may thus display information regarding the grid and participation in the grid, including comparisons between grid nodes. WebDynpro page may include one or more icons 812, which represent a thumbnail or graphical image that displays information, and/or links to information. Data 814-816 represent different types of data about the grid network that may be displayed. Data 814-816 may include any data discussed above. WebDynpro page 810 and its contents may use different icons and color schemes to display the grid information. WebDynpro page 810 may be the display of an application, a part of a display for an application, a standalone application, or a screensaver. As with other applications on a desktop of workspace, WebDynpro page 810 may be “open” on the desktop, and visible to the user, or behind another application. Alternatively, WebDynpro page 810 could be scheduled to periodically appear and give information, or WebDynpro page 810 may be generated in response to a user request (e.g., via a mouse click). In the case that WebDynpro page 810 is a screensaver, it may execute at an idle period of the host computing device.

FIG. 9 is a block diagram of an embodiment of a user display showing grid data in response to activating an icon. WebDynpro page 910 of user display 900 could include anything mentioned above with respect to grid information WebDynpro page 810 of FIG. 8. Taskbar 902 includes icon 930 that may be activated by pointer 920. Icon 930 is located in taskbar 902, but may be located anywhere with respect to user display 900, including in an application, on the desktop, or as a link in a pop-up window or mouse-over pop-up. Selecting or activating icon 930 can bring up one or more items of the grid information in WebDynpro page 910. Thus, WebDynpro page 910 may be rendered in response to triggering of icon 930 by pointer 920.

WebDynpro page 910 with the grid information may be configurable, to define how the information will be displayed. For example, a mouse-over of icon 930 may trigger an overview of grid information, with several links or objects shown, but no data or displays. Alternatively, an interactive graphic may be displayed in response to a mouse-over. When something within WebDynpro page 910 is selected, more detailed information may be shown. In one embodiment double-clicking icon 930 opens WebDynpro page 910 in a similar fashion as WebDynpro page 810 of FIG. 8. The display configuration can be configured beforehand allowing a grid interface module to automatically display information according to the preferences of a user. This may be useful for showing more detailed information to a department manager and less detailed information to a lower-echelon employee, for example. These settings may be pulled from enterprise data or system initialization settings, based on the user log-in information.

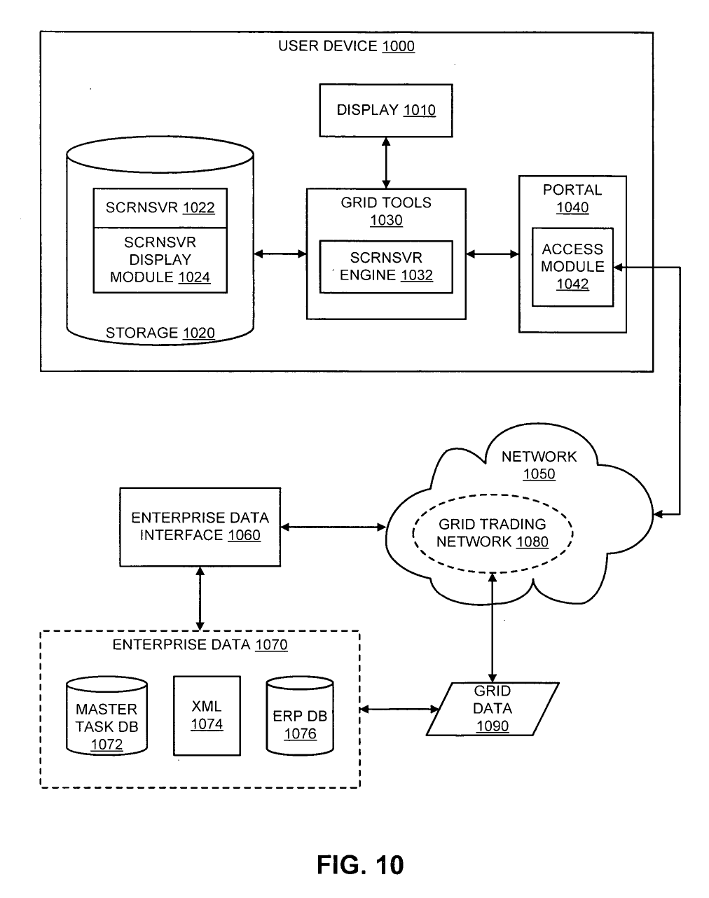

FIG. 10 is a block diagram of an embodiment of a user device having grid tools including a screensaver engine. User device 1000 provides one example of a computing device as previously discussed. User device 1000 includes display 1010 for presenting grid information to a user. Display 1010 receives the grid information for display, and/or the configuration for displaying the grid information from grid tools 1030. In one embodiment grid tools 1030 includes screensaver engine 1032, which allows grid tools 1030 to generate and execute a screensaver. Screensaver engine 1032 may enable grid tools 1030 to access screensaver display module 1024vto have the functionality of providing a screensaver on display 1010 with the grid information/objects. User device 1000 may include storage 1020 with screensaver 1022, which represents a screensaver application that will trigger upon detection of an idle period on user device 1000. Screensaver 1022 may in turn access screensaver display module 1024, which represents a function of screensaver 1022, or a separate module that provides one or more functions or calls or routines that provide one or more screensavers with the ability to provide the screensaver display. For example, the functions that could be enabled include clearing the display, executing after a certain time period, providing a particular display, providing an interrupt or an interrupt response to return control of the display back to the last state upon activity on the user device (cursor movement, keyboard touch, touchscreen press, etc.).

Screensaver display module 1024 may represent a generic screensaver function that may be accessed from a local screensaver, or from the enterprise. Screensaver display module 1024 may not be stored in storage 1020, but may exist in a memory of user device 1000. Screensaver 1022 and/or screensaver display module 1024 may be specifically associated with grid tools 1030 or some grid interface module, or it may be associated with a screensaver, and accessed by the grid interface module to derive the functionality necessary to provide grid information as a screensaver. Herein grid tools 1030 may represent the capabilities of a grid interface module. Thus, from one perspective each time grid tools are mentioned, there may be a grid interface module present that provides the tools.

User device 1000 includes portal 1040, which may be coupled with a grid interface module, and which provides access to grid tools 1030 to network 1050. Portal 1040 includes access module 1042, which represents one or more software modules to provide access to the network. In one embodiment access module 1042 is a WebDynpro View. Access module may be configurable and may provide a single access point to network 1050. Network 1050 represents the enterprise network structure, and in one embodiment may include part or all of grid trading network 1080. Grid trading network 1080 generates grid data 1090, or grid data 1090 represents the configuration, statistics, events occurring, etc., on grid trading network 1080.

Grid data 1090 represents information or data objects that may be accessed and used as with enterprise data 1070, which may include master task database 1072, XML element 1074, and/or ERP database 1076. Enterprise data 1070 and/or grid data 1090 may be accessible via enterprise data interface 1060. Enterprise data interface 1060 includes business logic, and may be or include an enterprise server.

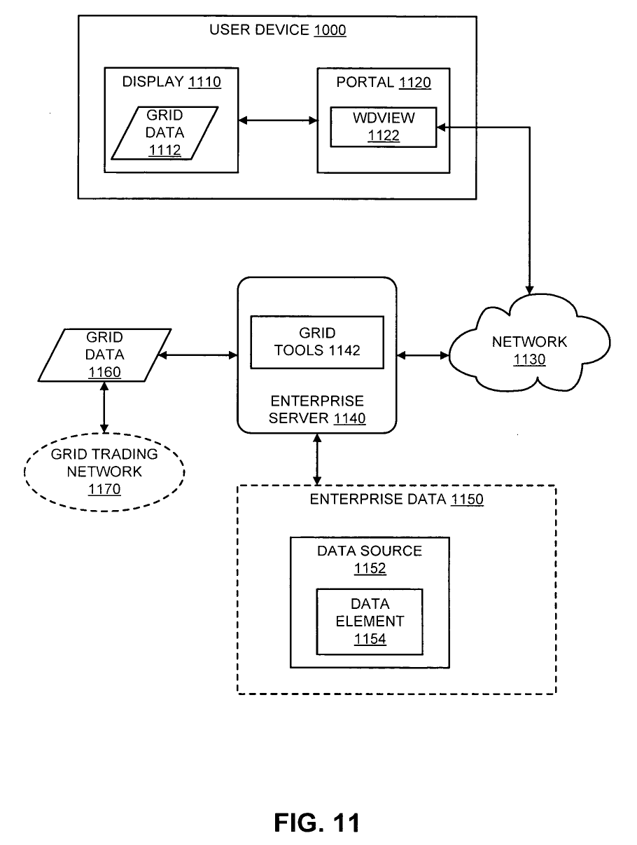

FIG. 11 is a block diagram of an embodiment of a user device with a display portal and an enterprise server having grid tools. User device 1100 represents a user device or computing device according to any previously described. User device 1100 includes display 1110 that displays grid data 1112, which is information related to grid use, and/or information for accessing grid objects. Display 1110 may receive grid data 1112 from portal 1120 through WebDynpro View 1122, as previously described.

Portal 1120 access network 1130. In one embodiment network 1130 includes or is coupled to enterprise server 1140. Enterprise server 1140 may be a computing device including software and/or hardware to provide enterprise services, including data access services. In one embodiment enterprise server 1140 includes grid tools 1142. Grid tools 1142 of enterprise server 1140 represent one or more functions that are passed to or applied on user device 1100 to provide grid data 1112 on display 1110. In one embodiment grid tools 1142 represent tools or interface modules that work with a grid interface module on user device 1100. Thus, enterprise server 1140 may generate functionality that is rendered on user device 1100. Grid tools 1142 may be tools that reside at the user device, or may be services, functions, and/or processes provided by the enterprise for user device 1100 or another user device. Thus, portal 1120 on user device 1100 may access one or more grid tool services on enterprise server 1140. The inclusion of grid tools 1142 on enterprise server 1140 can centralize one or more functions of grid access, for example, the information gathering and display.

Grid data 1160 represents one or more items of information and/or data objects related to grid trading network 1170. Enterprise server 1140 may access one or more elements of grid data 1160 to provide grid data 1112 on display 1110. Enterprise server 1140 may also access enterprise data 1150, which may include one or more data sources 1152, which may in turn have one or more data elements 1154.

In one embodiment portal 1120 can access enterprise server 1140 and present credentials. Similarly, enterprise server 1140 can present credentials to portal 1120 for passing information from grid trading network 1170. Based on the identity of user device 1100, enterprise server 1140 may provide certain grid information. The grid information may be part of enterprise data 1150, or may be directly provided to enterprise server 1140 from grid trading network 1170. Thus, user device 1100 may participate in the grid, interact with one or more grid nodes, and/or perform work based on information or application/functions accessed through the enterprise. The enterprise may collect grid information based on one or more of these events.

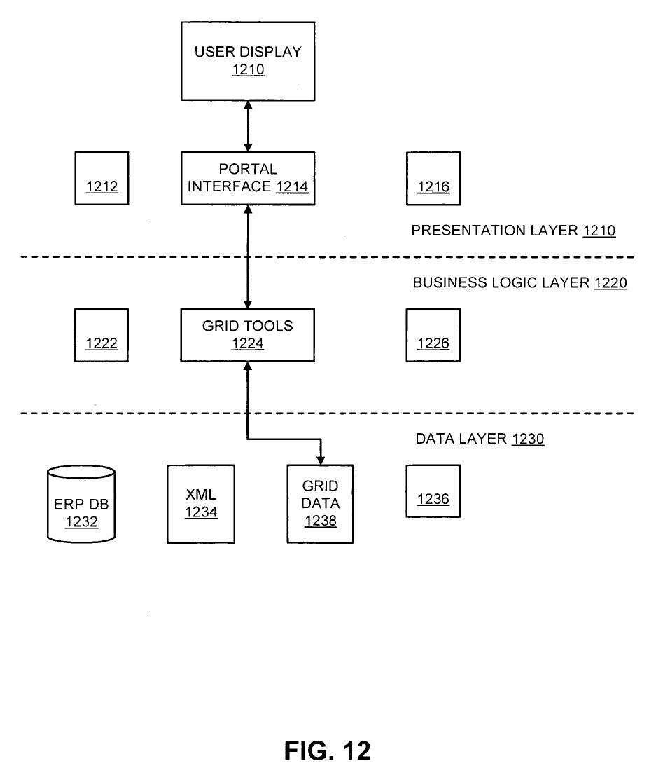

FIG. 12 is a block diagram of an embodiment of layers of an enterprise system to provide grid data to a user display. Data layer 1230 represents an abstraction of a logical layer in an enterprise or other information network where data is provided that can be accessed. Data can refer to any information or business object, and thus may also include services, or information for services. Specific data types shown include ERP database information 1232, XML item 1234, some data element 1236, and grid data 1238.

Business logic layer 1220 can perform functions, and may specifically have one or more elements of logic to provide grid tools 1224. Business logic layer 1220 may include other types of logic elements 1222 and 1226 to provide other functionality. Business logic may be one or more JAVA beans. As discussed above, one or more elements of the logic for grid tools 1224 may reside in the user device. FIG. 12 specifically shows grid tools 1224 accessing grid data 1238.

Presentation layer 1210 represents a logical layer to present accessed information to the user. Presentation layer 1210 may include one or more presentation elements 1212, and 1216, and may also include portal interface 1214. Portal interface 1214 can operate through grid tools 1224. Portal interface 1214 may include interface logic that allows accessed information to be passed to user display 1240. Thus, the enterprise may present grid data 1238 on user display 1240.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising:
accessing an enterprise-level business object of a grid network operating at least in part on resources of an enterprise network, the accessing including interfacing the enterprise network with a single-point network access portal; and
displaying the business object on a user display of a computing device to provide access to dynamic grid network data.

2. A method according to claim 1, wherein the business object comprises grid status indicator data.

3. A method according to claim 2, wherein the grid status indicator data comprises information about how many computers are participating in the grid network.

4. A method according to claim 2, wherein the grid status indicator data comprises one or more of a current task being executed on the computing device, a history of tasks worked on by the computing device, a number of processor operations performed by the computing device for the grid network, or a grid work contribution to date.

5. A method according to claim 2, wherein the grid status indicator data comprises information about how an amount of participation by the computing device compares to participation of another computing device.

6. A method according to claim 1, wherein the business object comprises grid participation parameter configuration data for the computing device.

7. A method according to claim 6, wherein the grid participation parameter configuration data comprises information indicating when the computing device will accept work from the grid network.

8. A method according to claim 6, wherein the grid participation parameter configuration data comprises information indicating an amount of resource capacity of the computing device can be allocated for participation of the computing device in the grid network.

9. A method according to claim 8, wherein the amount of resource capacity of the computing device comprises one or more of a percentage of operation of a central processing unit, an amount of memory for storing temporary grid information, or an amount of disk space for storing grid clients and data.

10. A method according to claim 6, wherein the grid participation parameter configuration data comprises information indicating a connection type.

11. A method according to claim 10, wherein the connection type comprises one or more of a wired local area network connection, a wireless local area network connection, or a dial-up connection.

12. A method according to claim 1, wherein the business object comprises security parameter configuration data for the computing device.

13. A method according to claim 12, wherein the security parameter configuration data comprises an interface to configure settings to respond to a request by the grid network to install software on the computing device.

14. A method according to claim 12, wherein the security parameter configuration data comprises an interface to configure access restrictions by the grid network to system memory on the computing device.

15. A method according to claim 12, wherein the security parameter configuration data comprises an interface to configure access restrictions by the grid network to system storage on the computing device.

16. A method according to claim 12, wherein the security parameter configuration data comprises information indicating authentication of the grid network with the computing device.

17. A method according to claim 16, wherein the information indicating authentication comprises information indicating when the grid network should authenticate with the computing device.

18. An article of manufacture comprising a machine-accessible medium having content to provide instructions to cause a machine to perform operations including:
accessing a data object related to dynamic status of a grid trading network through a configurable point of access to the grid trading network; and
displaying the data object as an interactive display element of a user display.

19. An article of manufacture according to claim 18, wherein the data object comprises a Java object representing one or more statistics related to the grid network including one or more of a number of computing devices participating in the grid network, a time of participation of a host computing device in the grid network, an amount of work contributed by the host computing device to the grid network, or a task being executed on the grid network.

20. An article of manufacture according to claim 18, wherein the data object comprises a Java object representing one or more configuration settings related to the grid network including one or more of a percentage of the processing power of a host computing device that can be utilized by the grid network, a network connection to use for the grid network, or whether the grid network can utilize the host computing device when the computing device is operating under battery power.

21. An article of manufacture according to claim 18, wherein the data object comprises a Java object representing one or more security settings related to the grid network including one or more of a condition on use of a host computing device's memory, a condition on use of the host computing device's storage, an authentication scheme between the host computing device and the grid network.

22. An article of manufacture according to claim 18, wherein the interactive display element comprises an icon including a link, the icon to be selected by a pointer device, the selecting of the icon triggering the link.

23. An apparatus comprising:
a network interface to couple the apparatus to a grid network;
a display interface to render an image on a user display, the image including a grid network object related to the grid network; and
a grid access interface module coupled with the network interface and the display interface to provide a single, configurable point of access to the grid network, to retrieve the grid network object related to an operation of the grid network, and send the retrieved grid network object to the display interface to render the image with the grid network object.

24. An apparatus according to claim 23, wherein the data object comprises an interactive object that is selectable and responsive to a selection, the selection resulting in an execution of a function.

25. An apparatus according to claim 24, wherein the execution of the function comprises one or more of a drill-down to more detailed information associated with the data object, an execution of an application related to the data object, or an access of a business process related to the data object.

26. An apparatus according to claim 23, wherein the single, configurable point of access to the grid network comprises an iView.

27. An apparatus according to claim 23, the grid access interface to retrieve the grid network object comprises the grid access interface to access the data object through an enterprise server.

28. An apparatus according to claim 23, wherein the grid network object comprises information related to a participation of a computing device other than the host computing device.
